(19) United States
(12) Patent Application Publication
(10) Pub. No.: US 2013/0055621 A1
(43) Pub. Date: Mar. 7, 2013

(54) FISHING ROD REST

(71) Applicant: GARY FONG, Chatfield, MN (US)

(72) Inventor: GARY FONG, Chatfield, MN (US)

(21) Appl. No.: 13/602,659

(22) Filed: Sep. 4, 2012

Related U.S. Application Data
(60) Provisional application No. 61/530,649, filed on Sep. 2, 2011.

(51) Int. Cl. A01K 97/10

(52) U.S. Cl. 43/21.2

(57) ABSTRACT

In combination with an elongated fishing implement, an article of manufacture includes an elongated body and one or more notches formed through a thickness of the elongated body in open communication with one edge surface thereof. Optional end notches, fasteners and track may be also provided.

### CROSS-REFERENCE TO RELATED APPLICATIONS

This application is related to and claims priority from U.S. Provisional Patent Application Ser. No. 61/530,649 filed on Sep. 2, 2011.

### FIELD OF THE INVENTION

The present invention relates, in general, to fishing boat accessories and, more particularly, this invention relates to fishing implement rests attachable to marine vehicles.

### BACKGROUND OF THE INVENTION

Fishing from a marine vehicle, such as boat, can require the fisherman to hold his rod (fishing implement) for long periods of time causing fatigue. If the rod is laid untouched on boat gunwales while trolling, it may slide around and perhaps even get pulled into the water by a large fish or snag. Therefore, boat fisherman have for years devised holders for their fishing rods to make the experience less fatiguing.

One example of such holder is the fishing pole and line holder disclosed by Shaw et al. in U.S. Pat. No. 4,753,029. Shaw teaches a considerable hardware addition to a boat. Mack in U.S. Pat. No. 4,157,803 teaches a removable rod holder that spans the width of the boat and has multiple short tubular holders. Emory in U.S. Pat. No. 4,527,349 discloses a trolling bar assembly with multiple tubular rod holders. The prior art in this field appears to be concentrated on tubular rod holders.

### SUMMARY OF THE INVENTION

The present invention provides, in combination with an elongated fishing implement, an article of manufacture including an elongated body and one or more notches formed through a thickness of the elongated body in open communication with one edge surface thereof.

The present invention also provides, in combination with an elongated fishing implement, an article of manufacture consisting of an elongated body, a first notch formed through a thickness of the elongated body in open communication with one edge surface thereof, a pair of second edge notches, and a fastener secured to another edge surface being opposite to the one edge surface having the one notch in open communication therewith. The first notch has a length in a direction aligned with a length of the elongated body being greater than a depth of the one notch in a direction normal to the length. Each of the pair of second edge notches defines a generally L-shape configuration of a respective end of the elongated body.

### OBJECTS OF THE INVENTION

It is, therefore, one of the primary objects of the present invention to provide simple fishing implement rests readily attachable without tools to existing marine vehicle gunnels.

Another object of the present invention is to provide a quiet and comfortable rest for multiple fishing implements used in a marine vehicle.

Still another object of the present invention is to provide a cost-effective fishing implement rest that is readily installed and removed.

It is, therefore, one of the primary objects of the present invention to provide, in combination with an elongated fishing implement, an article of manufacture comprising an elongated body and one or more notches formed through a thickness of the elongated body in open communication with one edge surface thereof.

Another object of the present invention is to provide an article of manufacture wherein one or more notches is a plurality of notches.

Yet another object of the present invention is to provide an article of manufacture wherein at least one notch includes a resilient tip.

A further object of the present invention is to provide an article of manufacture wherein the one or more notches is one notch.

Yet a further object of the present invention is to provide an article of manufacture that includes a pair of edge notches.

An additional object of the present invention is to provide an article of manufacture that further includes a pair of apertures.

Another object of the present invention is to provide a combination, wherein the article of manufacture includes a fastener.

A further object of the present invention is to provide an article of manufacture wherein the fastener is at least one of an adhesive, hook and loop fastener, adhesive tape and snaps.

Another object of the present invention is to provide a combination, wherein the article of manufacture includes a track and one or more tongues configured to mate with a slot of the track.

An additional object of the present invention is to provide an article of manufacture further including a marine vehicle or structure.

Another object of the present invention is to provide in combination with an elongated fishing implement, an article of manufacture consisting of an elongated body, a first notch formed through a thickness of the elongated body in open communication with one edge surface thereof, the first notch having a length thereof in a direction aligned with a length of the elongated body being greater than a depth of the one notch in a direction normal to the length, a pair of second edge notches, each of the pair of second edge notches defining a generally L-shape configuration of a respective end of the elongated body, and a fastener secured to another edge surface being opposite to the one edge surface having the one notch in open communication therewith.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 provides a perspective view of one embodiment of a an article of manufacture for holding an elongated fishing implement;

FIG. 2 is a perspective view of an article of manufacture for holding an elongated fishing implement, particularly illustrating resilient tips;

FIG. 3 provides a perspective view of an article of manufacture for holding an elongated fishing implement, particularly illustrating an elongated body including one notch and a pair of L-shaped edge notches;

FIG. 4 is an end elevation view of an article of manufacture for holding an elongated fishing implement, particularly illustrating, a pair of flexible and resilient flaps;

FIG. 5 is an end elevation view of an article of manufacture for holding an elongated fishing implement, particularly illustrating, a tongue configured to mount the article of manufacture in a track; and

FIG. 6 is an end elevation view of an article of manufacture for holding an elongated fishing implement, particularly illustrating, a pair of tongues configured to mount the article of manufacture in a track.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

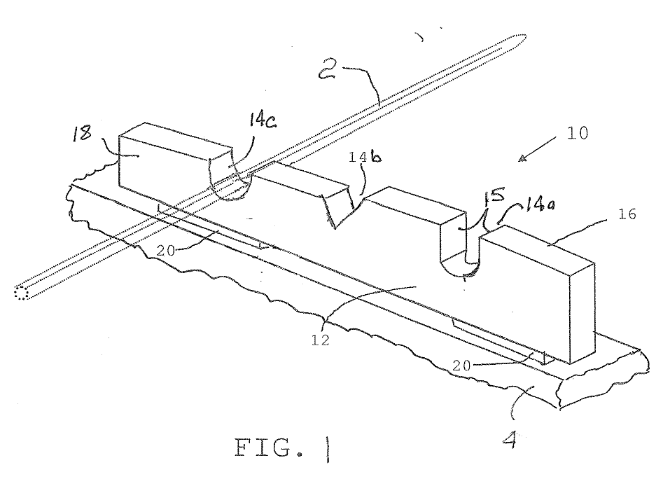

The best mode for carrying out the invention is presented in terms of its embodiments, herein depicted within FIGS. 1 through 3. However, the invention is not limited to the described embodiments, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The present invention describes an article of manufacture (herein described as the “article of manufacture”), for supporting a fishing implement, such as a rod or pole and is generally designated as 10.

Reference is now made, to FIGS. 1-3, wherein there is shown an article of manufacture, generally designated as 10, for holding or supporting an elongated fishing implement 2. The fishing implement 2 may be a fishing rod and/or a fishing pole such as a carbon fibre rod, a fly rod, a tenkara rod, an IM/Modulus, a spin and bait casting rod, a spinning rod, an ultra-light rod, an ice rod, a sea rod, a surf rod, a trolling rod, and/or a telescopic rod.

According to a first embodiment of the invention as illustrated in FIGS. 1-3, there is provided in combination with an elongated fishing implement 2, an article of manufacture 10 including an elongated body and 12 one or more notches 14 formed through a thickness of the elongated body 12 in open communication with one edge surface 16 thereof. The cross-section of the elongated body 12 may be of any shape, for example rectangular, square, or oblong.

In one embodiment, the one or more notches 14 may be a plurality of notches disposed in a spaced apart relationship with each other along a length of the elongated body 12. For example, in one embodiment, the one or more notches 14 may be from about 1 to about 100 notches or more to accommodate any amount of fishing implements 2.

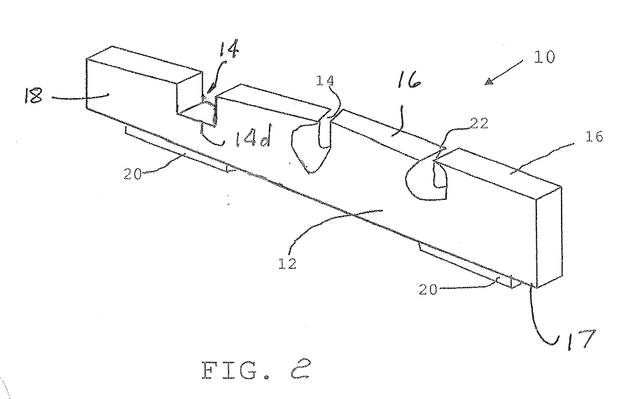

In one particular embodiment of the present invention that is illustrated in FIG. 2, at least one notch 14 includes an optional resilient tip 22 that is positioned in general alignment with the edge surface 16 of the elongated body 12 and that extends into the width of the at least one notch 14. The resilient tip 22 is configured to flex during passage of the fishing implement 2 into and from the at least one notch 14 and form a gap 24 at the edge surface 16. The gap 24 may be sized smaller than a width or diameter of the fishing implement 2. The resilient tip 22 is configured to allow the fishing implement 2 to be pushed down into the one or more notches 14 and is further configured to at least restrain if not completely eliminate unwanted movement of the fishing implement 2 in a vertical direction when the article of manufacture 10 is used, such as by something, for example fish, pulling on the hook end 2a of the fishing implement 2. In operation, the resilient tip or tips 22 will temporarily bend outwardly to the edge surface 16 when the fishing implement 2 is deliberately removed.

In another embodiment of the present invention, a width of the at least one notch 14 is sized smaller than the width or diameter of the fishing implement 2. In this embodiment, at least the material portion of the elongated body 12 around the at least one notch 14 is configured to allow insertion of the fishing implement 2 thereinto and return to the original shape after removal of the fishing implement 2 from the at least one notch 14.

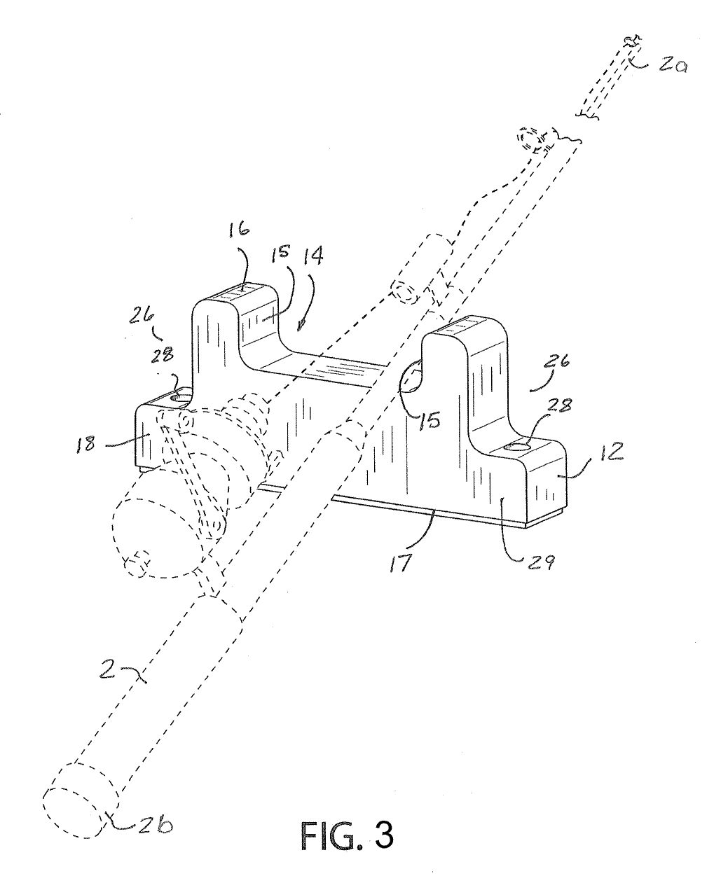

In one particular embodiment shown in FIG. 3, the one or more notches 14 is one notch 14. The one notch 14 has an elongated shape with a length thereof oriented in a direction aligned with a length of the elongated body 12 and being greater than a depth of the one notch 14 in a direction normal to the length thereof. The elongated body 12 may further include a pair of end notches 26. The end notches 26 can be any shape, for example L-shaped and can be straight edged or curved. Additionally, the article of manufacture 10 of this embodiment may include a pair of apertures 28, wherein each of the pair of apertures 28 is formed through a height 29 of the elongated body 12 in an area of a respective notch 26. The apertures 28 may have any shape and provide the installation of the article of manufacture 10 with conventional threaded fasteners (not shown) and with use of conventional tools to existing marine vehicle gunnels. In one embodiment of the claimed invention, the article of manufacture 10 may include a fastener 20 attached to another edge surface 17 being opposite to the edge surface 16 having the one or more notches 14 in open communication therewith. The fastener 20 may be at least one of an adhesive, hook and loop fastener, such as Velcro®, adhesive tape and/or snaps. It is presently preferred to use fastener 20 as a double-face adhesive tape which is advantageous in attachment of the article of manufacture 10 without any tools.

It is also contemplated that apertures 28 may be used in combination with fastener 20, such as the adhesive tape, as best shown in FIG. 3 and may further extend through the fastener 20. The fastener 20 may be provided as a plurality of pieces, as best shown in FIGS. 1-2.

The presently preferred material of the elongated body 12 is elastomer and, more particularly, a synthetic rubber copolymer if acrylonitrile (ACN) and butadiene type, such as nitrile rubber. In an alternative embodiment, the elongated body 12 may be manufactured from a semi-rigid polyurethane or polyolefin foam configured to compress and return to original shape or any other materials, including but not limited to metals, engineered plastics and wood. It is also contemplated to use a combination of materials, for example metal and elastomer, for applications requiring large size fishing implements 2.

In further reference to FIG. 1, a shape of the one or more notches 14 in a plane normal to a length of the elongated body is at least one of U-shape 14a, V-shape 14b, concave 14c, square 14d and elongated.

One particular embodiment of the present invention further includes a marine vehicle. The marine vehicle may be any type of watercraft or marine vessel and may include a ship, a boat or a hovercraft. In one particular embodiment, the elongated body 12 is at least temporarily secured to a portion of the marine vehicle. The portion of the marine vehicle may include at least one of a gunnel, an adjustable jointed rod assembly, transom and/or oar lock. In further reference to FIG. 1, such portion is partially illustrated as a gunnel 4.

An alternative embodiment of the present invention provides, in combination with an elongated fishing implement 2, an article of manufacture 10 consisting of an elongated body 12, a first notch 14 formed through a thickness of the elongated body 12 in open communication with the edge surface 16 thereof, a pair of second notches 26, each of the pair of second notches 26 defining a generally L-shape configuration of a respective end of the elongated body 12, and a fastener 20 secured to another edge surface 17 being opposite to the one edge surface 16 having the first notch 14 in open communication therewith. The first notch 14 has a length thereof in a direction aligned with a length of the elongated body 16 being greater than a depth of the one notch in a direction normal to the length.

In operation, the user at least temporarily attaches the above described article of manufacture 10 onto any desired portion of the marine vehicle, for example such as above described gunnel 4, and generally positions the fishing implement 2 at an angle into the notch 14 resting the handle end 2b on a surface (not shown) and essentially resting such fishing implement 2 on the edge surface of the notch 14. The walls 15 of the notch 14 or its shape at least constrain if not completely eliminate lateral movement of the fishing implement 2, enabling the user of the fishing implement 2 to attend to other matters without concern for lateral movement of the fishing implement 2 during use. Optional resilient tips 22 at least restrain if not completely eliminate movement of the fishing implement 2 in the vertical direction as may occur when large fish is pulling on the hook end 2a.

Although the present invention has been shown in terms of the article of manufacture 10 being attached at its (bottom) surface 17, it will be apparent to those skilled in the art, that the fastener 20 may be positioned on the front or back surface 18 and the apertures 28 may be formed through the thickness of the elongated body 12.

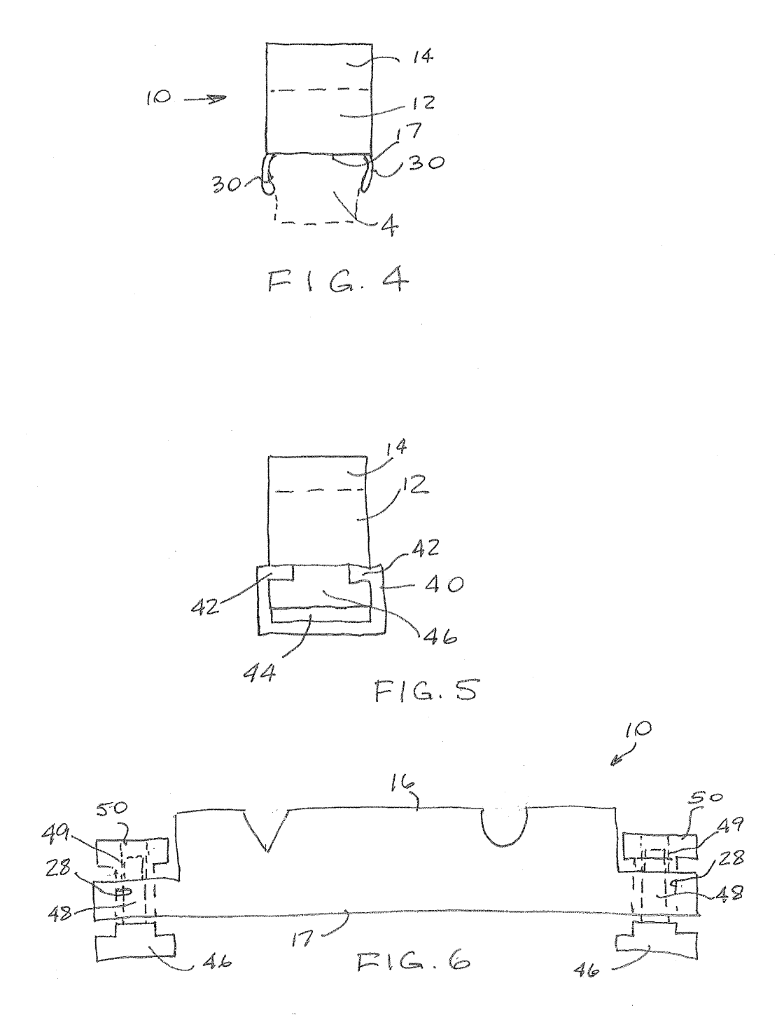

Now in a particular reference to FIG. 4, the article of manufacture 10 may include a pair of flexible and resilient flaps 30 extending from a surface of the elongated body 12, each of the pair of flexible and resilient flaps 30 disposed at a respective side edge of the elongated body 12, the pair of flexible and resilient flaps 30 configured to at least temporarily secure the article of manufacture 10 on an exterior surface of an elongated member, for example such as a gunnel 4. Although, the flaps 30 are shown in FIG. 4, as extending from the edge surface 17, it is contemplated that the flaps 30 may be extending from the front or back surface 18. It is not necessary in the instant invention for the flaps 30 to run the entire length of the elongated body 12.

Now in a particular reference to FIG. 5, the article of manufacture 10 may include a track 40 with an inwardly disposed flanges 42 and a hollow interior 44 and a tongue 46 disposed on a surface of the elongated body 12, the tongue 46 being shaped and sized to mate with a slot 44 of the track 40 so that a rotation or twist of the tongue 46 within the slot 44 at least temporarily secures the article of manufacture 10 on the track 40. The track 40 may be fastened by any conventional means on the marine vehicle (not shown) or may be integrated into a portion thereof. Although, the tongue 46 is shown in FIG. 5 as extending from the edge surface 17, it is contemplated that the tongue 46 may be disposed on the front or back surface 18. Furthermore, although the tongue 46 is shown as having a T-shape configuration, any other configurations, for example such as an L-shape configuration, are also contemplated. The tongue 46 is preferably positioned at equal distances from the ends of the elongated body 12 and may be made integral with or attached thereto. Thus, on marine vehicles equipped with the track 10, one or more articles of manufacture 10 may be easily secured at any selected positions and easily adjusted along the track 40 when required.

Now in a particular reference to FIG. 6, the tongue 46 may be positioned at each end of the elongated body 12 and adapted with a stem 48 sized to pass in a rotating manner, through apertures 28 and having a threaded end 49. Conventional knob 50 is then employed to thread onto the threaded end 49 and apply clamping force so as to mount the article of manufacture 10 on the track 40 of FIG. 5 after the tongue 46 is positioned and is properly oriented within the slot 44.

Knobs 50 and threaded fasteners (not shown) may be also employed with the article of manufacture 10 of FIG. 3.

Knob 50 may be also replaced with a toggle type handle (not shown) attached to the end of the stem 48.

It would be understood that fastener 20, apertures 28, flaps 30 and one or more tongues 46 provide means for at least temporarily securing the article of manufacture 10 to a portion of a marine vehicle.

The article of manufacture 10 is also advantageous when the fishing implement 2 is positioned generally horizontally or may be even inclined downwardly and outwardly from the gunnel 4.

It is also contemplated that the article of manufacture 10 can be at least temporarily secured in any of the above described manners to a any other structures, for example such as a railing of a peer (not shown), that is often used for resting the fishing implement 2 thereonto during fishing effort.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. In combination with an elongated fishing implement, an article of manufacture comprising:
(a) an elongated body; and
(b) one or more notches formed through a thickness of said elongated body in open communication with one edge surface thereof.

2. The combination of claim 1, wherein said one or more notches is a plurality of notches disposed in a spaced apart relationship with each other along a length of said elongated body.

3. The combination of claim 1, wherein at least one notch includes a resilient tip positioned in general alignment with said edge surface and extending into width of said at least one notch, said tip is configured to flex during passage of the fishing implement into and from said at least one notch and form a gap at said edge surface, said gap sized smaller than a width or diameter of the fishing implement.

4. The combination of claim 1, wherein a width of said at least one notch is sized smaller than a width or diameter of the fishing implement and wherein material portion of said elongated body around said at least one notch is configured to allow insertion of the fishing implement thereinto and return to original shape after removal of the fishing implement from said at least one notch.

5. The combination of claim 1, wherein said one or more notches is one notch.

6. The combination of claim 5, wherein said one notch has a length thereof in a direction aligned with a length of said elongated body being greater than a depth of said one notch in a direction normal to said length.

7. The combination of claim 5, wherein said elongated body further include a pair of edge notches.

8. The combination of claim 7, wherein said article of manufacture includes a pair of apertures, each of said pair of apertures formed through a height of said elongated body in an area of a respective notch.

9. The combination of claim 1, wherein said article of manufacture includes a fastener attached to another edge surface being opposite to said one edge surface having said one or more notches in open communication therewith.

10. The combination of claim 9, wherein said fastener is at least one of an adhesive, hook and loop fastener, adhesive tape and snaps.

11. The combination of claim 1, wherein elongated body is manufactured from a semi-rigid polyurethane or polyolefin foam configured to compress and return to original shape.

12. The combination of claim 1, wherein a shape of said one or more notches in a plane parallel to a length of said elongated body is at least one of V-shape, U-shape, concave, square and elongated.

13. The combination of claim 1, further including a marine vehicle or structure and wherein said elongated body is at least temporarily secured to a portion of said marine vehicle or structure.

14. The combination of claim 13, wherein said portion includes at least one of a gunnel, an adjustable jointed rod assembly, transom and oar lock.

15. The combination of claim 1, further including a track with an inwardly disposed flanges and a tongue disposed on a surface of said elongated body, said tongue is shaped and sized to mate with a slot provided within said track so that a rotation of said tongue within said slot at least temporarily secures said article of manufacture on said track.

16. The combination of claim 1, further including a pair of flexible and resilient flaps extending from a surface of said elongated body, each of said pair of flexible and resilient flaps disposed at a respective side edge of said elongated body, said pair of flexible and resilient flaps configured to at least temporarily secure said article of manufacture on an exterior surface of an elongated member.

17. The combination of claim 1, further including means for at least temporarily securing the article of manufacture to a portion of a marine vehicle or a portion of a structure used during fishing effort.

18. In combination with an elongated fishing implement, an article of manufacture consisting of:
(a) an elongated body;
(b) a first notch formed through a thickness of said elongated body in open communication with one edge surface thereof; and
(c) a pair of second notches, each of said pair of second edge notches being disposed at a respective end of said elongated body.

19. In combination with an elongated fishing implement, an article of manufacture consisting of:
(a) an elongated body;
(b) a first notch formed through a thickness of said elongated body in open communication with one edge surface thereof, said first notch having a length thereof in a direction aligned with a length of said elongated body being greater than a depth of said one notch in a direction normal to said length;
(c) a pair of second notches, each of said pair of second edge notches defining a generally L-shape configuration of a respective end of said elongated body; and
(d) a fastener secured to another edge surface being opposite to said one edge surface having said one notch in open communication therewith.
